(19) United States
(12) Patent Application Publication
(10) Pub. No.: US 2006/0220886 A1
(43) Pub. Date: Oct. 5, 2006

(54) Pro Locator Fire Sniffer

(76) Inventor: Ronald E. Robertson, Weddington, NC (US)

Correspondence Address: SAFE Fire Detection, Inc., 5915 Stockbridge Drive, Monroe, NC, 28110, US

(21) Appl. No.: 10/933,906

(22) Filed: Sep. 2, 2004

(51) Int. Cl. G08B 17/12

(52) U.S. Cl. 340/577

(57) ABSTRACT

A Pro Locator Fire Sniffer is a portable air sampling smoke and fire detector that utilizes a fan to draw air into the detector via a sampling tube and/or probe. It is an early warning air-sampling self-contained handheld portable incipient detector system, which allows the user to enter the environment and scan the area for abnormal levels of over heating which gives smoke, flame, fire, smoldering detector early warnings of smoke and fire. An audible and visual notification will be produced to help locate the fire/smoke. The closer you get to the source of the fire/smoke the higher the reading and faster audible signals. A probe can be used to locate fire/smoke inside equipment or hard to reach areas. A shoulder strap can also be used for ease of operation. Batteries or 110AC can also operate it.

Your petitioner a citizen of the United States and a resident of Weddington, N.C. prays that letters patent may be granted for the design for a Pro Locator Fire Sniffer as set forth in the following specifications. The claimed fire sniffer is used as a handheld/portable fire/smoke locator.

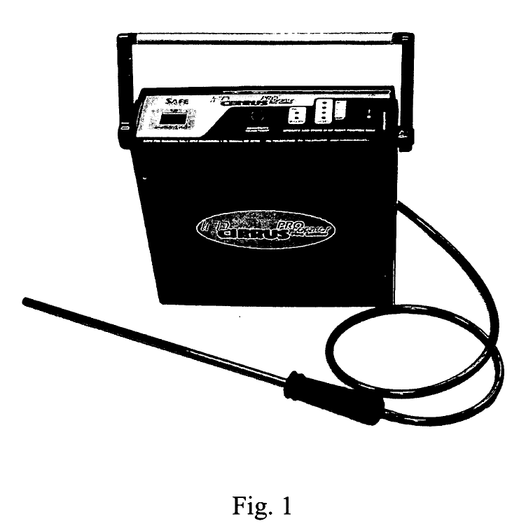

FIG. 1 is a front elevational view of a fire sniffer showing my design

1-14. (canceled)

15. I claim that the Pro Locator Fire Sniffer is used as a handheld portable and mobile early warning air sampling/aspirating incipient fire/smoke detector and environmental monitor that can be used to monitor the environment for overheating, fire, fire odors, smoke, incipient smoke, heat, chemicals, pollutants while not false alarming to dust, dirt and other contaminants that cause other systems to false alarm and is mobile to give the operator the freedom to move freely to pin point and locate the source of the fire/smoke or incipient event and can be carried around the environment with or without the use of it's shoulder strap and it's sampling probe as it operates on DC batteries or can be plugged into the wall to operate on A/C current as well so the operator is free to locate the source of the fire/smoke or incipient event

16. I claim the ProLocator Fire Sniffer in claim #1 has adjustable sensitivity settings and alarm levels to help determine the exact location of the overheating, fire, fire odors, smoke, incipient smoke, heat, chemicals, pollutants or incipient event and has both visual and audible indicators to help guide and determine the amount or level of signal that is received as well as the location of the source of the event.

17. I claim that the ProLocator Fire Sniffer in claim #1 draws air into the unit via a fan or aspirator through it's sample point or sample probe and passes the air sample into the detector which analyzes the air for overheating, fire, fire odors, smoke, incipient smoke, heat, chemicals, pollutants and incipient early warning events and gives an early warning of the event while locating the event by being both mobile and portable while allowing the sample probe to be inserted into cabinets, equipment and hard to reach areas both indoors and outside in any type of environment.
